(19) United States
(12) Patent Application Publication
(10) Pub. No.: US 2004/0006485 A1
(43) Pub. Date: Jan. 8, 2004

(54) Manufacturing integrated circuits

(75) Inventors: J. Tracy Weed, San Jose, CA (US); Christophe Pierrat, Santa Clara, CA (US); Yagyensh (Buno) Pati, Woodside, CA (US); Atul Sharan, Cupertino, CA (US)

Correspondence Address: NUMERICAL, C/O BEVER HOFFMAN & HARMS, LLP, 2099 GATEWAY PLACE, SUITE 320, SAN JOSE, CA, 95110-1017, US

(73) Assignee: Numerical Technologies, Inc., San Jose, CA

(21) Appl. No.: 09/752,809

(22) Filed: Dec. 27, 2000

(51) Int. Cl. G06F 17/60

(52) U.S. Cl. 705/1; 700/117

(57) ABSTRACT

Techniques are provided for manufacturing phase-shifted masks. According to one technique, a facilitator provides, on behalf of a set of one or more parties that desire masks, subsidies for production of phase-shifted masks. The manufacture of the phase-shifted masks is paid using compensation that includes the subsidies from the facilitator. One or more mask makers manufacture the phase-shifted masks for the compensation. The facilitator receives, from the set of one or more parties, compensation for the subsidies based on one or more factors including a factor that reflects market success of integrated circuits produced using the phase-shifted masks. In addition to the subsidies, the facilitator may provide a variety of value-added services.

### FIELD OF THE INVENTION

The invention relates to the manufacture of integrated circuits and, more particularly, to the manufacture of integrated circuits using phase-shifted masks.

### BACKGROUND OF THE INVENTION

To fabricate an integrated circuit (IC), engineers first use a logical electronic design automation (EDA) tool, also called a functional EDA tool, to create a schematic design, such as a schematic circuit design consisting of symbols representing individual devices coupled together to perform a certain function or set of functions. The schematic design must be translated into a representation of the actual physical arrangement of materials upon completion, called a design layout. If materials must be arranged in multiple layers, as is typical for an IC, the design layout includes several design layers.

After the arrangement of materials by layer is designed, a fabrication process is used to actually form material on each layer. That process includes a photo-lithographic process using a mask having opaque and transparent regions that causes light to fall on photosensitive material in a desired pattern. For example, after light is shined through the mask onto a photosensitive material (positive resist), the light-sensitive material is subjected to a developing process to remove those portions exposed to light (or, alternatively, remove those portions not exposed to light by using a negative resist). Etching, deposition, diffusion, or some other material altering process is then performed on the patterned layer until a particular material is formed with the desired pattern in the particular layer. The result of the process is some arrangement of material in each of one or more layers, here called printed features layers.

Because of the characteristics of light in photolithographic equipment, and because of the properties of the material altering processes employed, the pattern of transparent and opaque areas on the mask is not the same as the pattern of materials on the printed layer. A mask design process is used, therefore, after the physical EDA process and before the fabrication process, to generate one or more mask layouts that differ from the design layers. When formed into one or more masks and used in a set of photolithographic processes and material altering processes, these mask layouts produce a printed features layer as close as possible to the design layer.

Various approaches are being used to make masks, where the more expensive mask design approaches tend to yield superior results. A current technique for creating superior mask designs involves phase-shifting. Phase-shifting is a technology that reduces IC feature sizes using existing semiconductor processes. By incorporating phase-shifting into the design-to-silicon flow, users can consistently and reliably shrink IC feature sizes providing a significant improvement in chip performance.

Phase-shifting utilizes optical interference to improve depth-of-field and resolution in lithography. Phase-shifting operates on a fundamentally different principle from that used for conventional lithography. Phase-shifting technology is described in detail in U.S. Pat. No. 5,858,580 issued on Jan. 12, 1999, entitled “Phase shifting circuit manufacture method and apparatus”, and may be implemented using technology available from Numerical Technologies, Inc.

Referring to FIG. 1, phase-shifters appear as rectangles separated by a regulator piece of chrome. In this technique, one side of the shifter is 0° (i.e. “unshifted”) and the other is 180° out of phase. The width of the regulator as well as the size of the shifters is critical. Etched quartz may be used as an alternative to addititive phase shift material.

By shrinking feature size, phase-shifting gives significant speed, power, and cost benefits. Phase-shifting as applied to semiconductor lithography was first introduced in 1982. However, it has required hand-application to both the mask and the IC, an expensive and time-consuming process. A hand-crafted, phase-shifted mask could take a year to produce. This made phase-shifting cost prohibitive for most applications. Recent approaches to phase-shifting have automated the process of phase-shifting an IC layout. However, even when automated, creating phase-shifted masks still tends to be expensive.

The nature of the semiconductor manufacturing market is such that a relatively low percentage of integrated circuits are actual market “hits”. Rather, most integrated circuits make little or no profit, and frequently do not result in enough revenue to even cover the cost of manufacture.

FIG. 2 is a graph showing the amount of revenue generated by each integrated circuit in an exemplary population of integrated circuits. The integrated circuits fall into two general categories, labeled group 1 and group 2. Group 1, which contains the vast majority of the population, includes integrated circuits that generate little revenue, while the few members of group 2 generate substantial revenue. In general, it is the revenue from group 2 integrated circuits that makes integrated circuit manufacturing a profitable endeavor.

Unfortunately, it is usually not possible to determine whether an integrated circuit is going to fall into group 1 or group 2 before the integrated circuit hits the market. However, all of the manufacturing decisions have to be made prior to that time. In light of the relatively high market failure rate of integrated circuits, the manufacturing decisions made for a given integrated circuit are typically made so as to minimize the loss that will result if the integrated circuit turns out to be a group 1 integrated circuit.

One way to minimize the loss incurred by group 1 integrated circuits is to forego the additional expense associated with superior manufacturing technologies, such as the use of phase-shifting technology. For example, assume that conventional technology allows masks to be created for $10,000, while masks made with superior mask technologies cost $20,000. In this scenario, if all other parameters remained equal, the losses resulting from each group 1 integrated circuit made with superior mask technologies would be $10,000 greater than the losses incurred by each group 1 integrated circuit made with conventional mask technologies.

Within a semiconductor manufacturing company, it would be difficult to support manufacturing decisions that repeatedly incur additional $10,000 losses. In particular, the decision could result in a string of group 1 integrated circuits and the project being cancelled long before the semiconductor manufacturer encounters a group 2 integrated circuit whose market success justifies the use of the superior mask technology. Consequently, phase-shift technology or other advanced manufacturing technology may be underutilized even though its adoption would, on average, yield greater profits and better integrated circuits.

### SUMMARY OF THE INVENTION

Techniques are provided for manufacturing integrated circuits based on phase-shifted masks. According to one technique, a facilitator provides, on behalf of a set of one or more parties that desire masks, subsidies for production of phase-shifted masks. The manufacture of the phase-shifted masks is paid using compensation that includes the subsidies from the facilitator. One or more mask makers manufacture the phase-shifted masks for the compensation. The facilitator receives, from the set of one or more parties, compensation for the subsidies based on one or more factors including a factor that reflects market success of integrated circuits produced using the phase-shifted masks.

In addition to the subsidies, the facilitator may provide a variety of value-added services. For example, the facilitator may gather information relating to mask jobs sent to a variety of mask makers, and select or recommend the best mask maker for each job based on the information. The facilitator may even become established as a certification authority, certifying only those mask makers that achieve a certain level of quality and service.

As a result of using the techniques described herein, the various participants in the semiconductor industry benefit financially and at the same time the adoption of superior manufacturing techniques is accelerated. While it is not possible to enumerate all benefits that may result from these techniques, some of the benefits include improved access to emerging technologies, manufacture of integrated circuits that may have never been pursued in the absence of subsidies, increased competition in the emerging technologies, volume discounts, and lowered costs through economies of scale.

### BRIEF DESCRIPTION OF THE DRAWINGS

The invention is illustrated by way of example, and not by way of limitation, in the figures of the accompanying drawings and in which like reference numerals refer to similar elements and in which:

FIG. 1 is a diagram comparing a binary mask to a phase-shifted mask;

FIG. 2 is a chart illustrating revenues generated by a hypothetical population of integrated circuits manufactured from masks that use conventional techniques;

FIG. 3 is a block diagram illustrating a system in which a facilitator subsidizes adoption of phase-shifting technology according to an embodiment of the invention;

FIG. 4 is a block diagram illustrating the flow of information, money and products between a semiconductor manufacturer, a facilitator, and a mask maker, according to an embodiment of the invention; and

FIG. 5 is a chart illustrating revenues generated by the hypothetical population of integrated circuits of FIG. 2, if manufactured from masks using phase-shifting technologies according to an embodiment of the invention.

### DETAILED DESCRIPTION OF THE PREFERRED EMBODIMENT

Techniques for manufacturing semiconductors are described. In the following description, for the purposes of explanation, numerous specific details are set forth in order to provide a thorough understanding of the invention. It will be apparent, however, that the invention may be practiced without these specific details. In other instances, well-known structures and devices are shown in block diagram form in order to avoid unnecessarily obscuring the invention.

System Overview

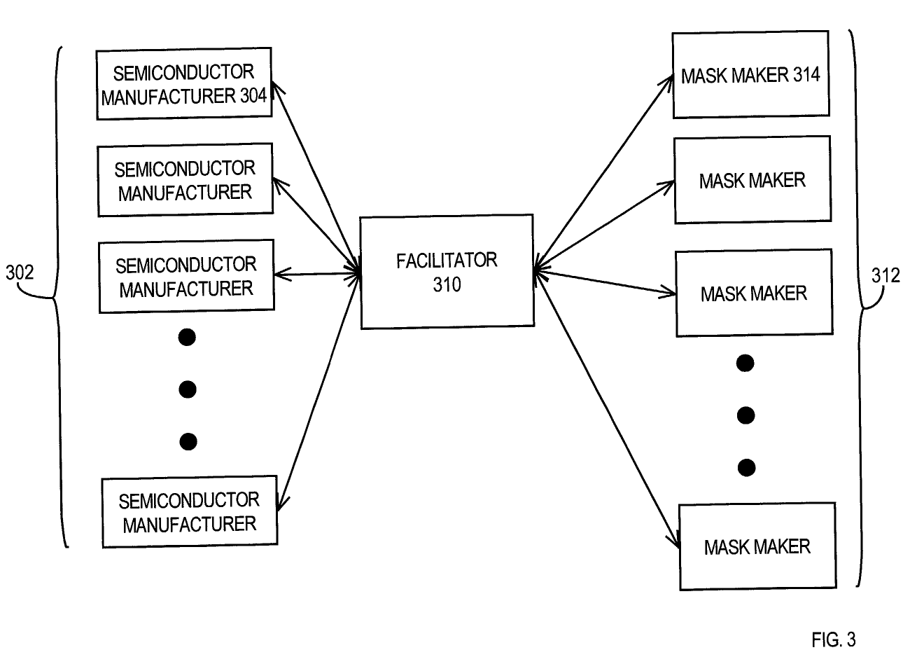

FIG. 3 is a block diagram of an integrated circuit manufacturing system according to an embodiment of the invention. Within the system, each semiconductor manufacturer of a group of semiconductor manufacturers 302 enters into a contract with a facilitator 310 for financing the manufacture of a population of integrated circuits. According to one embodiment, a manufacturer 304 and the facilitator 310 agree to split the cost of manufacturing phase-shifted masks for each integrated circuit in the population. In exchange for paying a portion of the manufacturing cost, the facilitator 310 receives compensation from the semiconductor manufacturer 304 in a manner that is tied to the market success of the resulting integrated circuit.

Because the cost of manufacturing phase-shifted masks is higher than the cost of manufacturing conventional masks, the losses that result from group 1 integrated circuits made with phase-shifted masks may be higher than the losses that result from group 1 integrated circuits made with conventional masks. However, the use of phase-shifted masks produces better integrated circuits. Because the products are better, the products tend to have better success in the market.

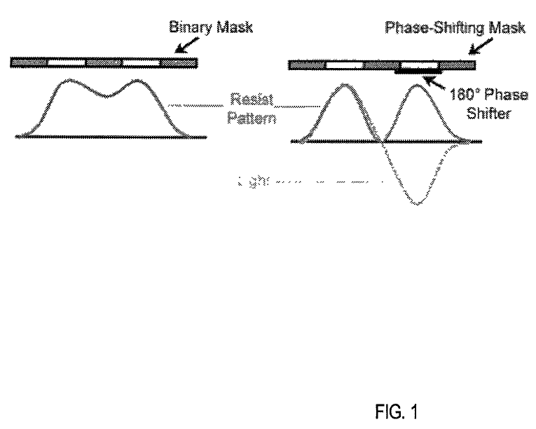

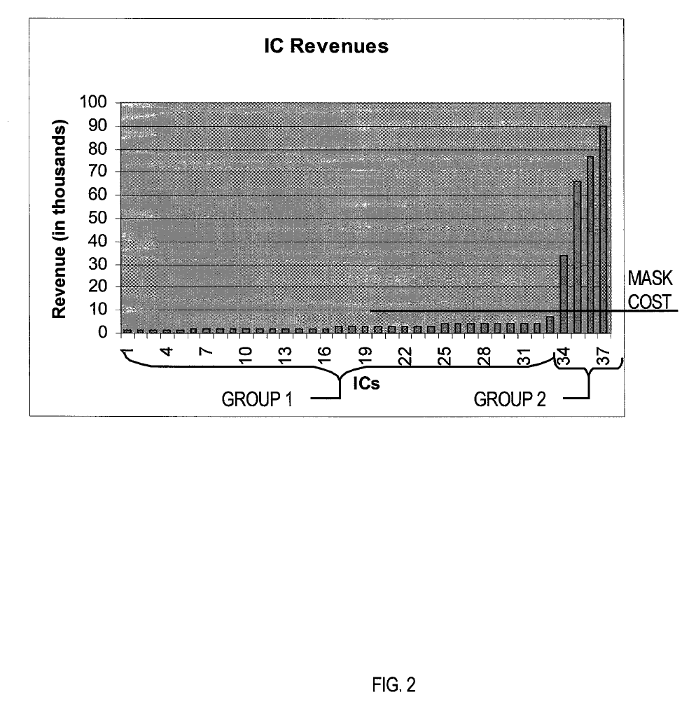

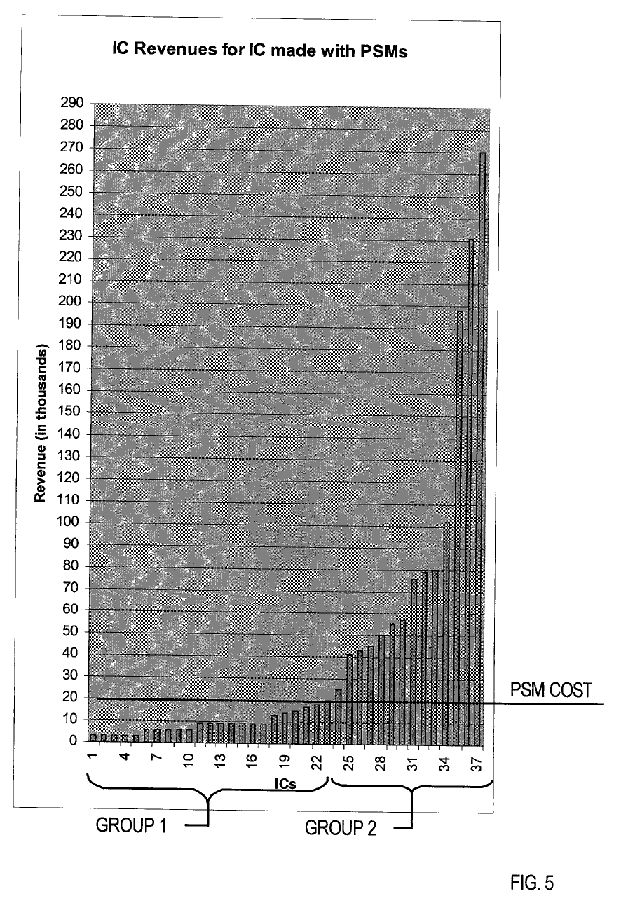

For example, FIG. 5 illustrates a scenario in which phase-shifted masks are used to produce the same semiconductor population as is illustrated in FIG. 2. In FIG. 5, each integrated circuit has higher revenue than its corresponding circuit in FIG. 2. As expected, some of the group 1 integrated circuits in FIG. 5 incur higher losses than their counterparts in FIG. 2 due to the higher cost of using phase-shifted masks. However, the increased revenues achieved by the group 2 integrated circuits in FIG. 5 more than make up for those losses. In particular, the use of phase-shifted masks increases the likelihood that the resulting integrated circuits will be a success, so a larger percentage of the population in FIG. 5 falls into group 2. In addition, the circuits in group 2 of FIG. 5 are superior to the corresponding circuits in group 2 of FIG. 1, and therefore result in significantly more revenue. The increased revenue is such that, even after paying the facilitator 310, the semiconductor manufacturer obtains greater profit than if conventional masks were used without the facilitator 310.

Financing Manufacture of Phase-Shifted Masks

As mentioned above, the semiconductor manufacturer 304 and the facilitator 310 split the cost of manufacturing a mask using phase-shifting technology. The actual percentage of the cost paid by each party may vary from contract to contract based on a variety of factors. For example, the portion of the phase-shift mask cost paid by semiconductor manufacturer 304 (the “reduced mask cost”) may be established to be the cost that would be incurred by the semiconductor manufacturer 304 if the mask were to be manufactured without subsidies using conventional techniques (e.g. a binary mask). Alternatively, the reduced mask cost may be established to be the cost that would be incurred if the mask were to be manufactured without subsidies using intermediate-quality techniques. Intermediate-quality techniques (e.g. optical proximity correction “OPC”) are techniques that provide masks that result in superior integrated circuit manufacturing results to those that result from conventional manufacturing techniques, but not as good as those that result from the current best-performance techniques (e.g. phase shifting). In another alternative, the reduced mask cost may be established to be even less than the cost that would be incurred if the mask were to be manufactured using conventional techniques, or may even be zero.

The portion of the phase-shift mask cost paid by facilitator 310 (the “mask manufacture subsidy”) is the difference between the total cost for manufacturing the mask using phase shifting technology (the “total mask cost”) and the reduced mask cost. Thus, assuming that the total mask cost for an integrated circuit is $30,000 and the reduced mask cost for the integrated circuit is $10,000, the mask manufacture subsidy is $20,000. In general, the greater the mask manufacture subsidy, the more generous the contractual terms for compensating the facilitator 310 based on the success of the resulting integrated circuit.

Facilitator Compensation

In exchange for providing the mask manufacture subsidy, the facilitator 310 is compensated based on the success of the resulting integrated circuit. The actual terms of compensation may vary from implementation to implementation. For example, the facilitator compensation may simply be a percentage of the revenue received by semiconductor manufacturer 304 for sales of integrated circuits that belong to the integrated circuit population covered by the agreement with the facilitator 310.

In an alternative embodiment, the contract may establish facilitator 310 to be the owner of the resulting masks, and allow semiconductor manufacturer to “rent” the masks to generate integrated circuits based thereon. In this embodiment, the compensation of facilitator 310 is still tied to the success of the integrated circuits because the semiconductor manufacturer 304 will have to make more copies of successful integrated circuits, and will therefore have to rent the corresponding masks for longer periods of time.

In yet another alternative, the contract may compensate facilitator 310 based on the actual number of integrated circuits manufactured from the subsidized masks. Again, the compensation of facilitator 310 is still tied to the success of the integrated circuits because the semiconductor manufacturer 304 will have to make more copies of successful integrated circuits.

The amount of compensation received by facilitator 310, regardless of how determined, may be established to vary over the sales of a resulting semiconductor. For example, the compensation may be established at a certain percentage X of revenue from sales of the first 1000 units, at a different (typically lower) percentage Y of revenue from sales the next 10,000 units, and at another percentage Z of revenue from sales of any additional units.

Operational Example

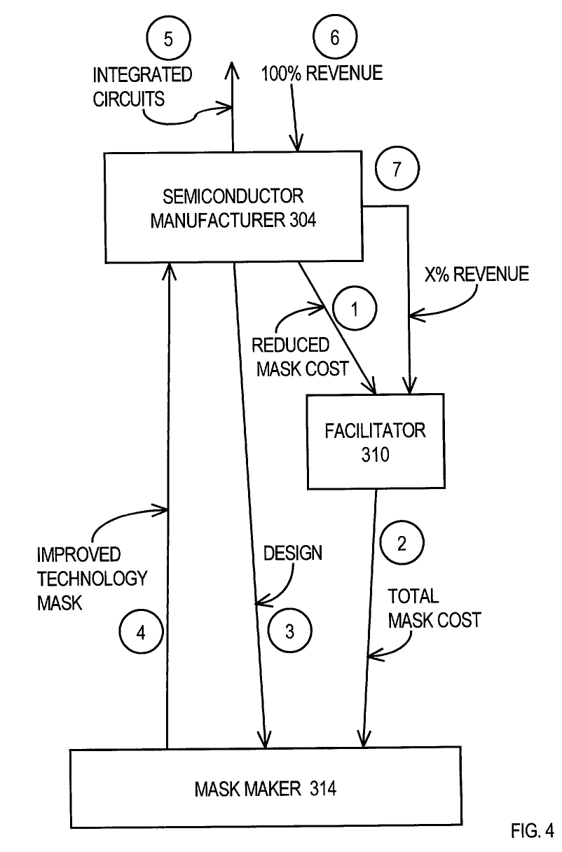

FIG. 4 is a block diagram illustrating the interactions that take place between semiconductor manufacturer 304, facilitator 310, and mask maker 314 to manufacture an integrated circuit according to an embodiment of the invention. Initially, semiconductor manufacturer 304 and facilitator 310 enter into an agreement under which facilitator 310 (1) subsidizes the manufacture of phase-shifted masks for a population of integrated circuits, and (2) receives compensation based on the success of that population of integrated circuits.

In the illustrated embodiment, semiconductor manufacturer 304 provides the reduced mask cost to facilitator 310 for the creation of a mask for an integrated circuit that will belong to that population. Facilitator 310 selects a mask maker to make the phase-shifted mask, and provides the total mask cost to the selected mask maker 314. In alternative embodiments, the semiconductor manufacturer 304 may select the mask maker 314, or may place restrictions on the discretion of facilitator 310 to choose a mask maker. For example, semiconductor manufacturer 304 may allow facilitator to choose only among those mask makers with which semiconductor manufacturer 304 has had a positive previous experience.

Semiconductor manufacturer 304 provides to the selected mask maker 314 (either directly or through facilitator 310) the design from which the mask is to be generated. The mask maker 314 then manufactures a phase-shifted mask (the “improved technology mask”) based on the design. The improved technology mask is provided to the semiconductor manufacturer 304, which starts manufacturing integrated circuits based on the improved technology mask. Those integrated circuits are sold, resulting in revenue received by semiconductor manufacturer 304. A percentage of that revenue is then provided to facilitator 310.

Value-Added Services

In the foregoing example, the role of facilitator 310 is limited to subsidizing the use of a superior but more expensive mask technology. However, as an intermediary between semiconductor manufacturers 302 and mask makers 312, facilitator 310 is in a unique position to provide numerous additional value-added services.

According to one embodiment, facilitator 310 monitors the service and quality of mask makers 312, and certifies those mask makers 312 that satisfy certain quality criteria. Consequently, when semiconductor manufacturers 302 delegate to facilitator 310 the selection of mask maker, they can be reasonably assured that a quality mask maker will be selected for the specific application. In addition, knowing that facilitator 310 is the source of certification, mask makers 312 will tend to give orders placed through facilitator 310 the highest quality service.

Mask makers 312 may have different strengths and weaknesses. For example, mask maker 314 may be better at making masks for certain types of designs than for other types of designs. According to one embodiment, facilitator 312 gathers information about how each job is handled by the mask maker to which it has been assigned, and thereby develops a knowledge base regarding the mask makers 312. This knowledge base may be employed to make intelligent decisions about which mask makers to use for particular jobs, and may be used as one factor in the certification process described above. Significantly, because the knowledge base that facilitator 310 establishes is based on information collected from jobs initiated by a plurality of semiconductor manufacturers 302, the knowledge base of facilitator 310 will be more extensive and accurate than the knowledge base that any individual semiconductor manufacturer would be able to develop on its own.

Facilitator 310 may also serve as a gatherer and repository of specific mask-related information on behalf of semiconductor manufacturers. In particular, facilitator 310 may cause mask makers 314 to provide information about each reticle they produce, including, for example, information that indicates the mask maker that produced the reticle, the process used to produce the reticle, the defects the were identified, how those defects were corrected, and various parameters associated with the reticle. This information can be encoded into the reticle itself, or may be provided by the mask makers 312 with the reticle.

Facilitator 310 may serve as a quality assurance department for the semiconductor manufacturers with which facilitator 310 deals. In particular, facilitator 310 may employ equipment and experts for determining the suitability of the masks delivered by mask makers 312. If a mask does not pass the quality assurance tests performed by facilitator 310, facilitator 310 works with the responsible mask maker to fix the problem rather than allow a faulty mask to be delivered to semiconductor manufacturer 304.

Over time, facilitator 310 will acquire expertise on how to best arrange for the production of masks (e.g. which mask maker to use in particular situations, etc.). To enhance the goodwill generated through the exercise of this expertise, facilitator 310 may desire to promote its own brand name. To that end, facilitator 310 may strip, or cause mask makers to strip any marks that identify the mask makers from the masks they produce for facilitator 310. Facilitator 310 may then place its own marking on the masks, or have the mask makers place a marking for facilitator 310, prior to supplying the masks to the semiconductor manufacturers.

A stepper simulation tool, such as the stepper simulation tool generally available from Numerical Technologies, Inc., is a mechanism for simulating the printed components that would result from use of a mask. Stepper simulation tools are particularly useful in identifying which flaws that exist in a mask actually require correction. Mask flaws that do not have a negative impact on the components printed from the mask do not have to be corrected. According to one embodiment, facilitator 310 may use a stepper simulation tool to provide the value added service of determining which flaws within subsidized masks have to be corrected, and providing that information back and forth to the mask makers that produced the flawed mask, to modulate customer interaction as well as enhance the ability to involve available experts in the decision process. A stepper simulation tool may also be used during the quality assurance inspection mentioned above, where a mask may be rejected based on a determination that the printed components that would be produced from the mask would have unacceptable flaws.

Facilitator 310 may also provide information acquired through the use of a stepper simulation tool to the semiconductor manufacturer for which a subsidized mask was created. With that information, the semiconductor manufacturer may be able to adjust the parameters of the actual stepper that will be used with the mask to produce integrated circuits that do not have unacceptable flaws. The ability to compensate for an otherwise flawed mask in this manner may be important if, for example, there are severe time constraints on the production of the integrated circuits and the creation of a corrected mask would incur an unacceptably long delay.

Volume Discounts

In most industries, entities that purchase higher volumes are able to obtain better prices than those that purchase lesser volumes. To take advantage of higher volume discounts, facilitator 310 may provide subsidizing services to a plurality of semiconductor manufacturers 302, as illustrated in FIG. 3. Thus, even though the mask manufacture requests made by facilitator 310 are for many semiconductor manufactures, the prices afforded to facilitator 310 by a mask maker 314 will typically take into account the total volume of orders made through facilitator 310. Consequently, even though the cost of a phase-shifted mask may have been $20,000 to semiconductor manufacturer 304, the exact same mask may only cost the facilitator $18,000.

Such volume discounts reduce the cost of subsidizing the mask manufacturing process, and therefore reduce the compensation that facilitator 310 will have to receive from the semiconductor sales for the subsidization. The lower that compensation, the more the revenue the semiconductor manufacturer retains for itself.

Ancillary Effects

Use of a facilitator in the manner described herein increases the adoption rate of new technologies. The increased use of the new technologies produces ancillary effects that render the techniques even more beneficial. For example, large-scale use of the new technology tends to produce both increased competition and economies of scale in the phase-shifted mask manufacturing market. Consequently, the greater the use of phase-shifted masks, the less expensive the manufacture of phase-shifted masks becomes.

Another likely ancillary effect of the increased use of phase-shifted masks is the improved responsiveness for orders of phase-shifted masks. In particular, when the vast majority of a mask maker's revenue is from orders for conventional masks, orders for other types of masks, such as phase-shifted masks, will tend to be relegated to a position of secondary importance. The mask makers may actually consider such orders more trouble than they are worth. On the other hand, if the volume of phase-shifted masks surpasses a certain threshold, the phase-shifted mask market will take on new importance to mask makers, inevitably resulting in improved service for those placing phase-shifted mask orders.

As the phase-shifted mask market gains importance, mask makers will shift research and development efforts and money to the improvement of that technology. Consequently, the rate of improvement of phase-shifted mask technology will increase, thereby driving down the cost of phase-shifted masks and increasing the performance gains that result from the use of phase-shifted masks.

Another ancillary effect of subsidization of mask manufacture is that, because the semiconductor manufacturer is paying below-market rates for mask production, the semiconductor manufacturer will choose to create masks for a greater number of designs than would be chosen in the absence of the subsidies. It is possible that some of the designs that otherwise would not have been pursued actually turn out to be successful group 2 designs. This is particularly important when integrated circuit designers that do not own their own fabrication facilities must convince a semiconductor manufacturer to produce integrated circuits for their designs. The semiconductor manufacturers will be more likely to accept jobs that they would otherwise refuse because the loss they will experience if the integrated circuits are not successful has been reduced by the subsidy.

Facilitator-Mask Maker Relations

According to one embodiment, facilitator 310 submits jobs to mask makers 312 in the same manner as would the semiconductor manufacturer 304 if the mask were not being subsidized. However, because facilitator 310 is handling jobs from a plurality of semiconductor manufacturers 302, the flow of work from facilitator 310 to mask makers 312 will be both higher volume and more constant than it is from individual semiconductor manufacturers 302. Consequently, in alternative embodiments, facilitator 310 may enter into types of agreements with mask makers 312 that would not be feasible for individual semiconductor manufacturers.

For example, according to one embodiment, facilitator 310 purchases “options” from mask makers 312, where the options commit a mask maker 314 to perform a certain volume of future work for facilitator 310 at a particular price. The price established by the option would be reduced relative to the normal price of the work, in exchange for the up-front money received by mask maker 314 for the option. Because the facilitator 310 works with a plurality of semiconductor manufacturers 302, the likelihood that the facilitator 310 will have sufficient future work to take full advantage of the option is high.

Facilitator-Semiconductor Manufacturer Relations

Each of semiconductor manufacturers 302 may have different motivations for working with facilitator 310 to place orders for masks. As mentioned above, many of semiconductor manufacturers 302 may desire to create integrated circuits using advance masks while still avoiding the increased losses that result when such circuits are not successful in the market. However, other semiconductor manufacturers may simply wish to take advantage of the volume discount prices that facilitator 310 may be able to obtain from mask makers.

Yet other semiconductor manufacturers may simply desire to defer the expense of masks by having facilitator 310 finance at least a portion of the masks under an agreement in which the semiconductor manufacturer pays facilitator 310 after, or over, an extended period of time. The longer the period during which a semiconductor manufacturer spreads the financing, the more likely that one of the integrated circuits produced by the masks will turn out to be a group 2 integrated circuit. A portion of the revenue from the group 2 integrated circuit can then be used to pay for the financing.

Facilitator-Semiconductor Manufacturer Agreement

The actual agreement between the facilitator 310 and semiconductor manufacturers will vary from situation to situation based on a variety of factors. However, it will typically include provisions that cover the following issues:

Population Definition. As mentioned above, the agreement need not cover all semiconductors produced by a semiconductor manufacturer. Rather, the agreement may be limited to a specific population of integrated circuits. For example, the agreement may cover all digital signal processors (DSPs) developed by the semiconductor manufacturer, or all 0.10 micron technology chips developed by the semiconductor manufacturer.

If the agreement covers a population of integrated circuits, the agreement will have to define the population with sufficient specificity as to not allow semiconductor manufacturers to make “end runs” around facilitator 310. For example, under certain circumstances, a semiconductor manufacturer 304 may be able to determine that a particular design will produce a successful group 2 integrated circuit. If the integrated circuit produced from that design is not considered part of the population covered by the agreement, facilitator 310 will not receive any revenues from its success. If the semiconductor manufacturer is allowed to remove group 2 integrated circuits from the population covered by the agreement, then facilitator 310 will not receive the compensation anticipated by the agreement. Consequently, the definition of the population covered by the agreement must be definite enough to give the semiconductor manufacturer no discretion with respect to whether a particular integrated circuit belongs to the population covered by the agreement.

Audit Rights. Facilitator 310 will want to verify the accuracy of the numbers that serve as the basis for the compensation of facilitator 310. For example, if the agreement covers a population of integrated circuits, facilitator 310 will want access to information to independently determine that it is receiving compensation for all integrated circuits that belong to the population. Similarly, if facilitator 310 is compensated based on revenue from sales of integrated circuits, facilitator 310 will have to access information to independently verify the alleged revenue amounts provided by the semiconductor manufacturers.

Minimum Compensation. If the compensation of facilitator 310 is based entirely on the success of the subsidized integrated circuits, it is possible for facilitator 310 to lose a significant amount of money. For example, facilitator 310 will lose money if it turns out that there were no group 2 integrated circuits in the entire population covered by the agreement. To reduce this risk, facilitator 310 may include a minimum compensation clause in the agreement. A minimum compensation clause may take many forms. In general, minimum compensation clauses indicate that if the semiconductor manufacturer has not paid the facilitator 310 at least some minimum amount under the agreement on or before a particular date, then the semiconductor manufacturer will pay on that particular date the difference between what has been paid and that minimum amount.

Royalty-Tracking Technologies

The techniques employed by facilitator 310 for tracking royalties will differ based on a variety of factors, including the contractually established basis used to determine royalties. Under certain circumstances, royalty-tracking technologies may be employed. For example, if royalties are computed based on the number of semiconductors produced from each subsidized mask, then some form of counter may be installed on the stepper equipment used to produce the semiconductors. The counter may take the form, for example, of software that uses the mask ID to track the number of wafer exposures.

Alternatively, the counting function may be performed by embedding or placing some type of device on the mask itself. Such a counting device may be configured to detect and count the occurrence of some event (such as light flashes) that occurs in the presence of the mask during the production of each integrated circuit. Preferably, such circuitry would also include a mechanism to detect attempts to tamper with the event detection circuitry.

According to another embodiment, facilitator 310 may “watermark” designs of the integrated circuits that belong to the population covered by the contract. Such watermarks may take the form, for example, of the digital watermarks produced using technology available from Digimarc Corporation. In particular, facilitator 310 may adjust the design in such a way that the integrated circuits produced from the design exhibit some detectable characteristic that does not impair the functionality of the integrated circuits. By using such a watermark, the facilitator 310 may resolve disputes over whether a particular batch of integrated circuits is covered by the contract by determining whether the integrate circuits reflect the detectable characteristic imposed by the design watermark.

The Integrated Circuit Designer

While the designs used to create masks are typically provided by the semiconductor manufacturer, the integrated circuits designs themselves may actually be created by a third party for whom the semiconductor manufacturer is going to make the integrated circuits. In particular, while some vertically integrated companies perform both circuit design and IC fabrication, other companies perform only circuit design or only IC fabrication.

In the previous discussion, embodiments have been described in which the subsidy agreement is between the semiconductor manufacturer and the facilitator 310. However, the agreement may alternatively be between an integrated circuit designer and the facilitator 310, or between the facilitator 310 and both the integrated circuit designer and the semiconductor manufacturer.

Alternative Mask-Making Techniques

In the foregoing discussion, embodiments have been described in the context of the semiconductor manufacturing industry and, more particularly, in the context of mask manufacturing where phase-shifting technologies are superior to, but more expensive than, conventional technologies. However, the techniques described herein are not limited to those contexts. Rather, they represent techniques that may be applied in a variety of contexts to increase the dissemination of emerging technologies.

For example, within the semiconductor manufacturing industry, the facilitator 310 may subsidize the manufacture of any form of masks that use a technology that is superior to, but more expensive than, conventional technologies. For example, facilitator 310 may subsidize the manufacture of masks made by Next Generation Lithography (NGL) technologies in exchange for compensation based on the success of the resulting semiconductors. Next Generation Lithography or NGL, generally includes any non-optical lithographic technique that will be used in the manufacturing of integrated circuits beyond the capability of optics. In addition, NGL may include optical solutions based on the 157 nm (F2) laser. Currently, NGL solutions can encompass a range of resolutions from 180 to below 35-nms and a range of exposure wavelengths down to 50A ( EUV). One definition of NGL is any technology that uses wavelengths below 20 nm.

There are many different approaches to NGL, with some of the top methods being Proximity X-ray lithography (1× x-ray), Electron Projection Lithography (EPL), Extreme UltraViolet (EUV), and Ion Projection (IPL).

Within the EPL umbrella there are two variants being developed - Scattering with Angular Limitation Projection Electron beam Lithography (SCALPEL) and Projection Reduction Exposure with Variable Axis Lenses (PREVAIL).

EPL technology is based on a flood exposure of high energy electrons projected through either a 4× stencil mask (PREVAIL) or a 4× scattering mask (SCAPEL). Both mask types utilize a membrane to form the design images. IPL is also a 4× reduction system and uses a stencil mask similar to PREVAIL although ions are used for the lithography. EUV uses a reflective optics (currently a 10× reduction system that uses 40 pair layers of MoSi on the mirrors and masks rather than the quartz used today for high end masks) to project the image on an absorbing layer on a reflective mask.

EUV reflectivity requires exacting control (within angstroms) of these multi-layer reflective coatings on both the optical components as well as the mask substrate. The NGL subsidies may be instead of, or in addition to, the subsidization of phase-shifted masks.

General Technology Adoption Techniques

The techniques described herein are not limited to the context of the semiconductor manufacturing industry. Rather, the techniques may be applied in any context in which (1) each member of a product population has a relatively low chance of market success, (2) there is a relatively high probability that at least one member of the product population will achieve market success, (3) a plurality of manufacturing techniques are available for manufacturing the products, including a less-expensive inferior technique and a more-expensive superior technique, and (4) prior to knowing whether a given member of the population is going to be successful, a decision has to be made about how to manufacture the member (or how to manufacture the entire population).

For example, assume that (1) a record company has a population of songs by unknown artists, each of which has a relatively low chance of market success, (2) there is a relatively high probability that at least one of the songs will be a hit, (3) a plurality of techniques are available to manufacture recordings of the songs, including a less-expensive inferior technique (e.g. analog stereo recording) and a more-expensive superior technique (e.g. digital surround sound recording), and (4) prior to knowing whether a given song is going to be successful, a decision has to be made about how to manufacture a recording of the song. In this context, a facilitator similar to facilitator 310 may provide a song recording subsidy to have all songs in the population recorded using the more-expensive superior technique, in exchange for compensation based on market success of the songs.

In the foregoing discussion, the superior manufacturing technology is said to be “more expensive” or have a higher “cost” than the inferior manufacturing technology. The nature of this cost may vary from implementation to implementation. For example, both the superior and the conventional technologies may be readily available, where the additional cost of the superior technology is merely a higher monetary price of using it. Alternatively, the price of using both technologies may be the same, but the superior technology may be available from a much more limited number of sources. In this situation, the higher cost associated with the superior technology is the cost of gaining access to those sources. The subsidy provided by the facilitator 310 in this situation may take the form of providing better access to the limited sources than the subsidized party would be able to obtain on its own.

In the embodiments described herein, facilitator 310 has been described as an entity separate from the semiconductor manufacturers and mask makers. However, this separation need not exist. For example, facilitator 310 may represent a department within or bundle of services provided by a semiconductor manufacturer, a mask maker, or one or more other parties interested in promoting the use of the superior technology. Facilitator 310 may even be affiliated with a not-for-profit organization, or a trade association.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of manufacturing phase-shifted masks, the method comprising the steps of:
providing, from a facilitator on behalf of a set of one or more parties that desire masks, subsidies for production of phase-shifted masks;
paying for manufacture of said phase-shifted masks using compensation that includes said subsidies from said facilitator;
causing a set of one or more mask makers to manufacture said phase-shifted masks for said compensation; and
receiving, by said facilitator from said set of one or more parties, compensation for said subsidies based on one or more factors including a factor that reflects market success of integrated circuits produced using said phase-shifted masks.

2. The method of claim 1 wherein, for a particular party in said set of one or more parties,
the facilitator agrees to provide subsidies for production of phase-shifted masks for a defined population of designs; and
the particular party agrees to compensate the facilitator for the subsidies based on a factor that reflects market success of each and every integrated circuit produced by or for said particular party based on any design in said defined population of designs.

3. The method of claim 1 wherein:
the phase-shifted masks include a phase-shifted mask for a particular design;
manufacture of a mask for said particular design using an alternative technology would cost X;
manufacture of the phase-shifted mask for the particular design costs Y, where Y is greater than X; and
the step of providing subsidies includes providing a subsidy that is substantially equal to Y-X for manufacture of said phase-shifted mask for said particular design.

4. The method of claim 1 wherein the step of compensating the facilitator includes a party from said set of one or more parties paying the facilitator based on number of integrated circuits manufactured using a phase-shifted mask that was subsidized by the facilitator.

5. The method of claim 1 wherein the step of compensating the facilitator includes a party from said set of one or more parties paying the facilitator for rental of a phase-shifted mask that was subsidized by the facilitator.

6. The method of claim 1 wherein the step of compensating the facilitator includes a party from said set of one or more parties paying the facilitator based on revenues derived from integrated circuits manufactured using a phase-shifted mask that was subsidized by the facilitator.

7. The method of claim 6 wherein the party pays the facilitator a per-unit amount that decreases with increased volume of sales of integrated circuits manufactured using said phase-shifted mask.

8. The method of claim 1 wherein the set of one or more parties includes a plurality of parties.

9. The method of claim 1 wherein the set of on e or more mask makers includes a plurality of mask makers.

10. The method of claim 8 wherein the set of one or more mask makers includes a plurality of mask makers.

11. The method of claim 1 further comprising the step of the facilitator certifying mask makers that satisfy certain quality criteria.

12. The method of claim 1 further comprising the step of the facilitator selecting the one or more mask makers to manufacture said phase-shifted masks.

13. The method of claim 1 further comprising the step of the facilitator gathering information about jobs performed by mask makers, wherein said one or more mask makers are selected to manufacture said phase-shifted masks based on said information.

14. The method of claim 13 further comprising the step of the facilitator determining which mask makers to certify based on said information.

15. The method of claim 13 wherein the information includes information from the mask makers about reticles that they produce.

16. The method of claim 15 further comprising the step of the facilitator causing the mask maker to encode information about a particular reticle onto the particular reticle.

17. The method of claim 1 further comprising the step of the facilitator performing one or more quality assurance tests on said phase-shifted masks.

18. The method of claim 17 wherein the step of performing one or more quality assurance tests is performed for a given phase-shifted mask prior to the facilitator releasing said given phase-shifted mask to be used by a semiconductor manufacturer.

19. The method of claim 1 further including the facilitator using a stepper simulation tool to determine which flaws in said phase-shifted masks have to be corrected.

20. The method of claim 19 further comprising the steps of:
the facilitator providing information about a particular phase-shifted mask acquired through the use of the stepper simulation tool to a semiconductor manufacturer; and
the semiconductor manufacturer adjusting parameters on an actual stepper that is used with the particular phase-shifted mask based on the information.

21. The method of claim 1 further comprising the step of the facilitator obtaining a volume discount from a mask manufacturer based on a contract in which the facilitator agrees to use the mask manufacturer to produce phase-shifted masks for a plurality of semiconductor manufacturers.

22. The method of claim 1 further comprising the step of the facilitator purchasing an option from a mask maker that commits the mask maker to perform a certain volume of future work for the facilitator; and
wherein the step of causing a set of one or more mask makers to manufacture said phase-shifted masks includes said facilitator exercising said option.

23. The method of claim 1 wherein:
the compensation for said subsidies is based on the number of semiconductors produced by said phase-shifted masks; and
the method further comprises the steps of using a counter installed on stepper equipment to determine the compensation.

24. The method of claim 1 wherein:
the compensation for said subsidies is based on the number of semiconductors produced by said phase-shifted masks; and
the method further comprises the steps of placing a counter device on at least one of the phase-shifted masks to determine the compensation.

25. The method of claim 1 further comprising the step of facilitator causing designs of at least some of the integrated circuits produced using said phase-shifted masks to be watermarked.

26. A phase-shifted mask produced by a process that includes the steps of:
providing, by a facilitator on behalf of a party that desires a mask, a subsidy for production of said phase-shifted mask;
paying for manufacture of said phase-shifted mask using compensation that includes said subsidy from said facilitator;
causing a mask maker to manufacture said phase-shifted mask for said compensation; and
receiving, by the facilitator from said party, compensation for said subsidy based on one or more factors including a factor that reflects market success of integrated circuits produced using said phase-shifted mask.

27. An integrated circuit produced by a process that includes the steps of:
providing, by a facilitator on behalf of a party, a subsidy for production of said phase-shifted mask;
paying for manufacture of said phase-shifted mask using compensation that includes said subsidy from said facilitator;
causing a mask maker to manufacture said phase-shifted mask for said compensation;
manufacturing said integrated circuit based on said phase-shifted mask; and
receiving, by the facilitator from said party, compensation for said subsidy based on one or more factors including a factor that reflects market success of said integrated circuit.

28. A method of manufacturing masks using a particular technology when said particular technology is preferable to but cost more than one or more alternative technologies, the method comprising the steps of:
providing, from a facilitator on behalf of a set of one or more parties that desire masks, subsidies for production of masks using said particular technology;
paying for manufacture of said masks using compensation that includes said subsidies from said facilitator;
causing a set of one or more mask makers to manufacture said masks using said particular technology for said compensation; and
receiving, by said facilitator from said set of one or more parties, compensation for said subsidies based on one or more factors including a factor that reflects market success of integrated circuits produced using said masks.

29. The method of claim 28 wherein, for a particular party in said set of one or more parties,
the facilitator agrees to provide subsidies for production of masks for a defined population of designs; and
the particular party agrees to compensate the facilitator for the subsidies based on a factor that reflects market success of each and every integrated circuit produced by or for said particular party based on any design in said defined population of designs.

30. The method of claim 28 wherein:
the masks include a mask for a particular design;
manufacture of a mask for said particular design using an alternative technology would cost X;
manufacture of the mask for the particular design using said particular technology costs Y, where Y is greater than X; and
the step of providing subsidies includes providing a subsidy that is substantially equal to Y-X for manufacture of said mask for said particular design using said particular technology.

31. The method of claim 28 wherein the step of compensating the facilitator includes a party from said set of one or more parties paying the facilitator based on number of integrated circuits manufactured using a mask that was subsidized by the facilitator.

32. The method of claim 28 wherein the step of compensating the facilitator includes a party from said set of one or more parties paying the facilitator for rental of a mask that was subsidized by the facilitator.

33. The method of claim 28 wherein the step of compensating the facilitator includes a party from said set of one or more parties paying the facilitator based on revenues derived from integrated circuits manufactured using a mask that was subsidized by the facilitator.

34. The method of claim 33 wherein the party pays the facilitator a per-unit amount that decreases with increased volume of sales of integrated circuits manufactured using said mask.

35. The method of claim 28 wherein the set of one or more parties includes a plurality of parties.

36. The method of claim 28 wherein the set of one or more mask makers includes a plurality of mask makers.

37. The method of claim 35 wherein the set of one or more mask makers includes a plurality of mask makers.

38. The method of claim 28 further comprising the step of the facilitator certifying mask makers that satisfy certain quality criteria.

39. The method of claim 28 further comprising the step of the facilitator selecting the one or more mask makers to manufacture said masks.

40. The method of claim 28 further comprising the step of the facilitator gathering information about jobs performed by mask makers, wherein said one or more mask makers are selected to manufacture said masks based on said information.

41. The method of claim 40 further comprising the step of the facilitator determining which mask makers to certify based on said information.

42. The method of claim 40 wherein the information includes information from the mask makers about reticles that they produce.

43. The method of claim 42 further comprising the step of the facilitator causing the mask maker to encode information about a particular reticle onto the particular reticle.

44. The method of claim 28 further comprising the step of the facilitator performing one or more quality assurance tests on said masks.

45. The method of claim 44 wherein the step of performing one or more quality assurance tests is performed for a given mask prior to the facilitator releasing said given mask to be used by a semiconductor manufacturer.

46. The method of claim 28 further including the facilitator using a stepper simulation tool to determine which flaws in said masks have to be corrected.

47. The method of claim 46 further comprising the steps of:
the facilitator providing information about a particular mask acquired through the use of the stepper simulation tool to a semiconductor manufacturer; and
the semiconductor manufacturer adjusting parameters on an actual stepper that is used with the particular mask based on the information.

48. The method of claim 28 further comprising the step of the facilitator obtaining a volume discount from a mask manufacturer based on a contract in which the facilitator agrees to use the mask manufacturer to produce masks for a plurality of semiconductor manufacturers.

49. The method of claim 28 further comprising the step of the facilitator purchasing an option from a mask maker that commits the mask maker to perform a certain volume of future work for the facilitator; and
wherein the step of causing a set of one or more mask makers to manufacture said masks includes said facilitator exercising said option.

50. The method of claim 28 wherein:
the compensation for said subsidies is based on the number of semiconductors produced by said masks; and
the method further comprises the steps of using a counter installed on stepper equipment to determine the compensation.

51. The method of claim 28 wherein:
the compensation for said subsidies is based on the number of semiconductors produced by said masks; and
the method further comprises the steps of placing a counter device on at least one of the masks to determine the compensation.

52. The method of claim 28 further comprising the step of facilitator causing designs of at least some of the integrated circuits produced using said masks to be watermarked.

53. A method of manufacturing products using a particular technology when said particular technology is preferable to but cost more than one or more alternative technologies, the method comprising the steps of:
providing, from a facilitator on behalf of a set of one or more parties, subsidies for using said particular technology to manufacture products;
paying for manufacture of said products using compensation that includes said subsidies from said facilitator;
causing products to be manufactured for said compensation using said particular technology; and
receiving, by said facilitator from said set of one or more parties, compensation for said subsidies based on one or more factors including a factor that reflects market success of said products.

54. The method of claim 53 wherein, for a particular party in said set of one or more parties,
the facilitator agrees to provide subsidies for production of products for a defined population of designs; and
the particular party agrees to compensate the facilitator for the subsidies based on a factor that reflects market success of each and every article of manufacture produced by or for said particular party based on any design in said defined population of designs.

55. The method of claim 53 wherein:
the products include a product for a particular design;
manufacture of a product for said particular design using an alternative technology would cost X;
manufacture of the product for the particular design using said particular technology costs Y, where Y is greater than X; and
the step of providing subsidies includes providing a subsidy that is substantially equal to Y-X for manufacture of said product for said particular design using said particular technology.

56. The method of claim 53 wherein the step of compensating the facilitator includes a party from said set of one or more parties paying the facilitator based on number of articles of manufacture manufactured using a product that was subsidized by the facilitator.

57. The method of claim 53 wherein the step of compensating the facilitator includes a party from said set of one or more parties paying the facilitator for rental of a product that was subsidized by the facilitator.

58. The method of claim 53 wherein the step of compensating the facilitator includes a party from said set of one or more parties paying the facilitator based on revenues derived from articles of manufacture manufactured using a product that was subsidized by the facilitator.

59. The method of claim 58 wherein the party pays the facilitator a per-unit amount that decreases with increased volume of sales of articles of manufacture manufactured using said product.

60. The method of claim 53 wherein the set of one or more parties includes a plurality of parties.

61. The method of claim 53 wherein the set of one or more product makers includes a plurality of product makers.

62. The method of claim 60 wherein the set of one or more product makers includes a plurality of product makers.

63. The method of claim 53 further comprising the step of the facilitator certifying product makers that satisfy certain quality criteria.

64. The method of claim 53 further comprising the step of the facilitator selecting the one or more product makers to manufacture said products.

65. The method of claim 53 further comprising the step of the facilitator gathering information about jobs performed by product makers, wherein said one or more product makers are selected to manufacture said products based on said information.

66. The method of claim 65 further comprising the step of the facilitator determining which product makers to certify based on said information.

67. The method of claim 53 further comprising the step of the facilitator performing one or more quality assurance tests on said products.

68. The method of claim 67 wherein the step of performing one or more quality assurance tests is performed for a given product prior to the facilitator releasing said given product to said one or more parties.

69. The method of claim 53 further comprising the step of the facilitator obtaining a volume discount from a product manufacturer based on a contract in which the facilitator agrees to use the product manufacturer to produce products for a plurality of said one or more parties.

70. The method of claim 53 further comprising the step of the facilitator purchasing an option from a product maker that commits the product maker to perform a certain volume of future work for the facilitator; and
wherein the step of causing a set of one or more product makers to manufacture said products includes said facilitator exercising said option.

71. The method of claim 53 further comprising the step of facilitator causing designs of at least some of the articles of manufacture produced using said products to be watermarked.
